(19) United States
(12) Patent Application Publication
(10) Pub. No.: US 2025/0341674 A1
(43) Pub. Date: Nov. 6, 2025

(54) LOW LOSS AND STABLE PLANAR LIGHTWAVE CIRCUIT ATTACHMENT WITH SILICON INTERPOSER

(71) Applicant: MARVELL ASIA PTE LTD., Singapore (SG)

(72) Inventors: Hsiu-Che WANG, Oak Park, CA (US); Pushkraj TUMNE, Agoura Hills, CA (US); Dwayne R. SHIRLEY, Valley Glen, CA (US); Roberto COCCIOLI, Simi Valley, CA (US); Peikeng FU, Zhubei City (TW)

(21) Appl. No.: 18/871,793

(22) PCT Filed: Jun. 7, 2023
(86) PCT No.: PCT/US2023/024685

§ 371 Date: Dec. 4, 2024

Related U.S. Application Data
(60) Provisional application No. 63/349,615, filed on Jun. 7, 2022.

(51) Int. Cl. G02B 6/12; G02B 6/13; H04B 10/40

(52) U.S. Cl. CPC G02B 6/12004; G02B 6/13; H04B 10/40; G02B 2006/12121

(57) ABSTRACT

An optical signal transceiver includes a circuit board substrate, a silicon photonics-based interposer mounted on the circuit board substrate, the silicon photonics-based interposer including at least one of a waveguide configured to transmit optical communication signals and a photo detector configured to detect optical communication signals, and a planar lightwave circuit disposed on the circuit board substrate. The planar lightwave circuit is configured to perform at least a portion of propagation of light signals in an optical communication network, and the planar lightwave circuit is aligned with a side surface of the silicon photonics-based interposer to transmit optical communication signals between the silicon photonics-based interposer and the planar lightwave circuit. The optical signal transceiver includes at least one spacer component disposed between the planar lightwave circuit and the circuit board substrate, and epoxy material in contact with the spacer component.

### CROSS-REFERENCE TO RELATED APPLICATIONS

This application claims the benefit of U.S. Provisional Application No. 63/349,615, filed on Jun. 7, 2022. The entire disclosure of the application referenced above is incorporated herein by reference.

### FIELD

The present disclosure relates to optical signal transceivers including a silicon photonics-based interposer and a planar lightwave circuit, including spacers and epoxy material for mounting the planar lightwave circuit to a circuit board substrate for stable optical coupling with the silicon photonics-based interposer.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Broadband communication systems can include silicon photonics systems that are used to satisfy different bandwidth, signal-to-noise ratio, and power requirements for short-reach, metro, or long-haul data transmission. Silicon photonics devices can include active components and passive components. The active components can include modulators and photodetectors. The passive components can include power splitters, polarization splitter-rotators, and input and output couplers. The active and passive devices can be connected to each other using waveguides. In order to meet emerging broadband performance requirements, the passive components, active components and waveguides should be mutually spatially aligned to within very exacting tolerances.

### SUMMARY

An optical signal transceiver includes a circuit board substrate, a silicon photonics-based interposer mounted on the circuit board substrate, the silicon photonics-based interposer including at least one of a waveguide configured to transmit optical communication signals and a photo detector configured to detect optical communication signals, and a planar lightwave circuit disposed on the circuit board substrate. The planar lightwave circuit is configured to perform at least a portion of propagation of light signals in an optical communication network, and the planar lightwave circuit is aligned with a side surface of the silicon photonics-based interposer to transmit optical communication signals between the silicon photonics-based interposer and the planar lightwave circuit. The optical signal transceiver includes at least one spacer component disposed between the planar lightwave circuit and the circuit board substrate, and epoxy material in contact with the spacer component.

In other features, the epoxy material is disposed between the planar lightwave circuit and the at least one spacer component, or the epoxy material is disposed between the at least one spacer component and the circuit board substrate.

In other features, a first portion of the epoxy material is disposed between the planar lightwave circuit and the at least one spacer component, and a second portion of the epoxy material is disposed between the at least one spacer component and the circuit board substrate.

In other features, the at least one spacer component comprises at least one of a silicon material, a silicon dioxide material or a glass material. In other features, the at least one spacer component is absent any circuit elements. In other features, the at least one spacer component is embedded in the circuit board substrate.

In other features, a side surface of the planar lightwave circuit is spaced from the side surface of the silicon photonics-based interposer to define a gap between the side surface of the planar lightwave circuit and the side surface of the silicon photonics-based interposer, the at least one spacer component and the epoxy material located at a different surface of the planar lightwave circuit than the side surface of the planar lightwave circuit facing the silicon photonics-based interposer. At least a portion of the epoxy material is disposed in the gap defined between the side surface of the planar lightwave circuit and the side surface of the silicon photonics-based interposer.

In other features, a refractive index of the portion of the epoxy material disposed in the gap formed between the side surface of the planar lightwave circuit and the side surface of the silicon photonics-based interposer is matched to the refractive index of at least one of the silicon photonics-based interposer and the planar lightwave circuit.

In other features, the at least one spacer component includes a first spacer component and a second spacer component, the first spacer component and the second spacer component are coplanar, and a gap is defined between the first spacer component and the second spacer component.

In other features, the optical signal transceiver includes at least one laser diode coupled to the silicon photonics-based interposer, wherein the silicon photonics-based interposer is configured to receive an optical output from the at least one laser diode.

In other features, the at least one spacer component includes an upper surface, a lower surface, and at least one opening defined by a space between the upper surface and the lower surface.

In other features, the at least one spacer component includes multiple openings arranged in at least one row. In other features, at least a portion of the epoxy material is disposed in one or more of the multiple openings of the at least one spacer component.

In other features, the circuit board substrate includes an exposed metal plating layer, and at least a portion of the epoxy material is disposed between the at least one spacer component and the exposed metal plating layer.

In other features, a trench, defined in the circuit board substrate adjacent an edge of the at least one spacer component, is configured to receive portions of the epoxy material. In other features, a thermal coefficient of the at least one spacer component matches a thermal coefficient of the planar lightwave circuit.

In other features, the planar lightwave circuit includes one or more passive components, the one or more passive components including at least one optical waveguide. In other features, the circuit board substrate is an organic substrate.

A method of assembling an optical signal transceiver includes mounting a silicon photonics-based interposer on a circuit board substrate, the silicon photonics-based interposer including at least one of a waveguide configured to transmit optical communication signals and a photo detector configured to detect optical communication signals. The method includes mounting a planar lightwave circuit on the circuit board substrate, wherein at least one spacer component is disposed between the planar lightwave circuit and the circuit board substrate, and an epoxy material is in contact with the circuit board substrate, and adjusting a height of the planar lightwave circuit relative to the silicon photonics-based interposer to align the planar lightwave circuit with a side surface of the silicon photonics-based interposer to transmit optical communication signals between the silicon photonics-based interposer and the planar lightwave circuit.

In other features, the method includes applying a first portion of the epoxy material between the at least one spacer component and the circuit board substrate, and applying a second portion of the epoxy material between the at least one spacer component and the planar lightwave circuit.

In other features, the method includes concurrently curing the first portion of the epoxy material and the second portion of the epoxy material. In other features, the method includes attaching the at least one spacer component to the planar lightwave circuit prior to mounting the planar lightwave circuit on the circuit board substrate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is orthogonal view of an optical signal transceiver including a silicon photonics-based interposer and a planar lightwave circuit.

FIG. 2A is a side sectional view of an optical signal transceiver including a silicon photonics-based interposer and a planar lightwave circuit, illustrating epoxy material above and below a spacer component.

FIG. 2B is a side sectional view of an optical signal transceiver including a silicon photonics-based interposer and a planar lightwave circuit, illustrating epoxy material above a spacer component.

FIG. 2C is a side sectional view of an optical signal transceiver including a silicon photonics-based interposer and a planar lightwave circuit, illustrating epoxy material below a spacer component.

FIG. 3 is an orthogonal view of a silicon photonics-based interposer and a spacer component on a circuit board substrate.

FIG. 4 is an orthogonal view of a silicon photonics-based interposer and multiple spacer components arranged on a circuit board substrate.

FIG. 5 is an orthogonal view of a silicon photonics-based interposer and a spacer component on a circuit board substrate, illustrating the spacer with honeycomb holes.

FIG. 6 is an orthogonal view of a spacer component located on a bottom surface of a planar lightwave circuit.

FIG. 7 is an orthogonal view of a silicon photonics-based interposer and a metal layer on a circuit board substrate.

FIG. 8 is an orthogonal view of a silicon photonics-based interposer and a metal layer on a circuit board substrate, illustrating the metal layer with a patterned surface.

FIG. 9 is a side sectional view of an optical signal transceiver including a silicon photonics-based interposer and a planar lightwave circuit, illustrating a trench configured to collect overflow epoxy material.

FIG. 10 is a side sectional view of an optical signal transceiver including a silicon photonics-based interposer and a planar light wave circuit, illustrating epoxy material between the silicon interposer and the planar lightwave circuit.

FIG. 11 is a flowchart illustrating an example process for fabricating an optical signal transceiver including a silicon photonics-based interposer and a planar light wave circuit using a spacer component and epoxy material.

In the drawings, reference numbers may be reused to identify similar and/or identical elements.

### DESCRIPTION

Silicon photonics circuits used for broadband telecommunication, data center connectivity and bio-sensing applications employ various active components and passive components. Waveguide assemblies are used to optically route signals to various active and passive components. In some assemblies, a planar lightwave circuit (PLC) is optically coupled to a silicon photonics-based interposer. If the planar lightwave circuit is not attached to a substrate with stable support, warpage of the substrate may significantly reduce optical coupling between the planar lightwave circuit and the silicon photonics-based interposer.

Some example embodiments described herein include a spacer component and epoxy material between the planar lightwave circuit and a substrate, to reduce or minimize optical coupling losses between the planar lightwave circuit and the silicon photonics-based interposer. The spacer component and epoxy material may be used with silicon photonics-based interposers of different waveguide heights, using active or passive optical alignment with the planar lightwave circuit.

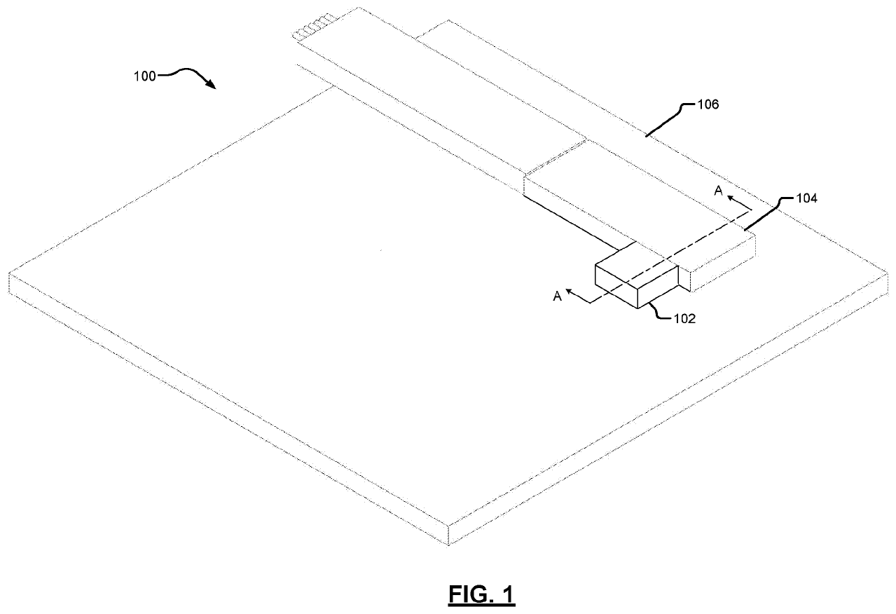

FIG. 1 shows an orthogonal view of an optical signal transceiver 100 including a silicon photonics-based interposer 102 and a planar lightwave circuit (PLC) 104. The silicon photonics-based interposer 102 is mounted on a circuit board substrate 106. The silicon photonics-based interposer 102 includes at least one of a waveguide configured to transmit optical communication signals and a photo detector configured to detect optical communication signals. In some example embodiments, components such as modulators, laser diodes, interferometers, splitters, etc., may be located in the silicon photonics-based interposer 102. Alternatively, or in addition, the components may be located external to the silicon photonics-based interposer 102, such as on the circuit board substrate 106.

The planar lightwave circuit 104 is disposed on the circuit board substrate 106. The planar lightwave circuit 104 is configured to perform at least a portion of propagation of light signals in an optical communication network. For example, the planar lightwave circuit may include one or more passive components, such as an optical waveguide that transmits optical communication signals to the silicon photonics-based interposer 102 as received from optical fibers of a communication network (e.g., in a receiver function), and/or receives optical communication signals from the silicon photonics-based interposer 102 for propagation to optical fibers of the communication network (e.g., in a transmitter function).

The planar lightwave circuit 104 is aligned with a side surface of the silicon photonics-based interposer 102 to transmit optical communication signals between the silicon photonics-based interposer 102 and the planar lightwave circuit 104. The planar lightwave circuit 104 should be in exacting alignment with the silicon photonics-based interposer 102 to avoid losses due to poor optical coupling if the are even slight variances in alignment. For example, as light signals are transmitted back and forth between the planar lightwave circuit 104 and the silicon photonics-based interposer 102, vertical and horizontal alignment tolerances must be very small because even misalignment of 1.5 microns, for example, may lead to a 1 dB loss in optical signal transmission, a 20% loss compared to exact alignment, etc.

Although FIG. 1 illustrates one example embodiment of a side of the silicon photonics-based interposer 102 aligned with a side of the planar lightwave circuit 104 adjacent an end of the planar lightwave circuit 104, in other example embodiments the silicon photonics-based interposer 102 may be aligned with the planar lightwave circuit 104, more than one silicon photonics-based interposer 102 and/or more than one planar lightwave circuit 104 may be aligned with each another, etc.

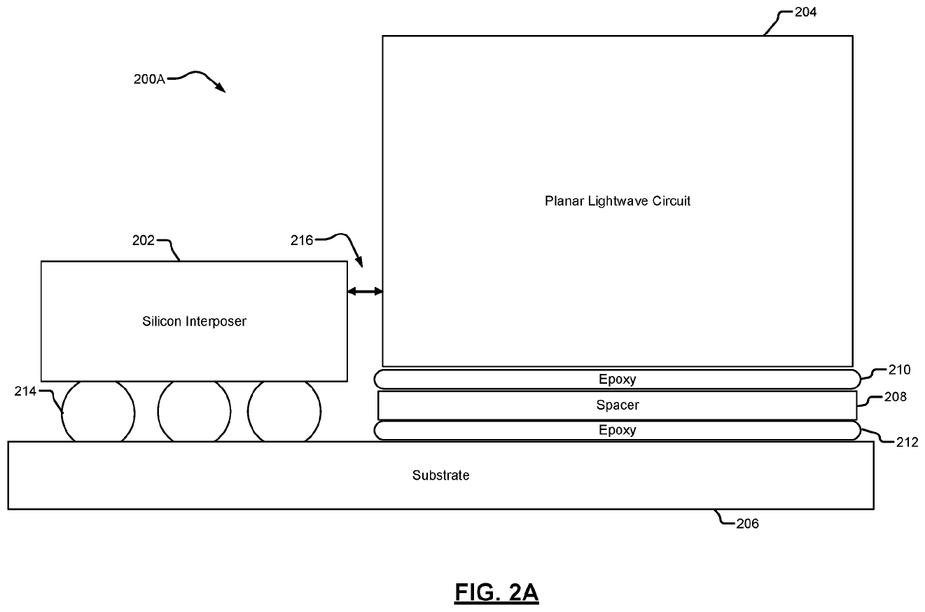

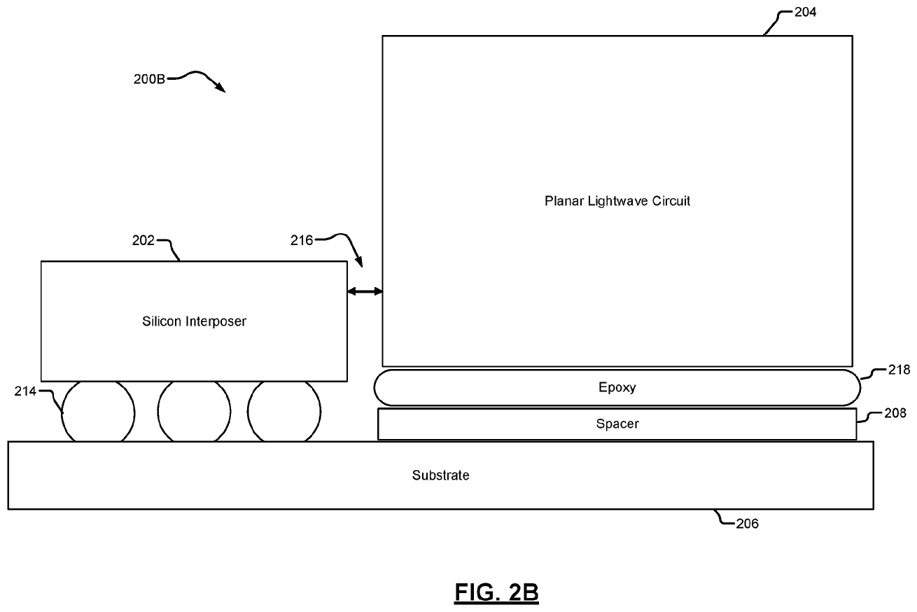

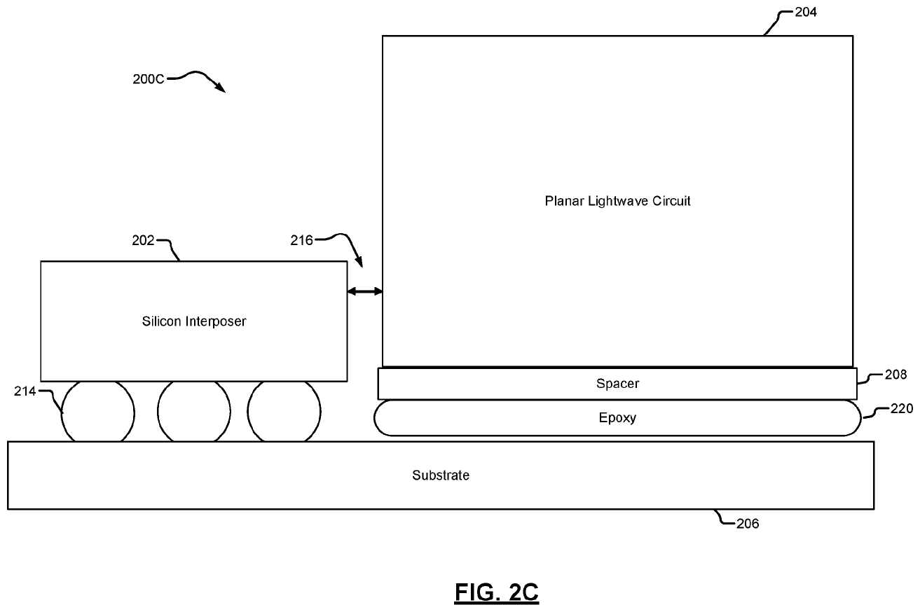

FIG. 2A is a side sectional view of an optical signal transceiver 200A including a silicon photonics-based interposer 202 and a planar lightwave circuit 204. A spacer component 208 is located below the planar lightwave circuit 204, between the planar lightwave circuit 204 and a circuit board substrate 206. A first layer 210 of epoxy material is in contact with the spacer component. In particular, in the example embodiment of FIG. 2A, the first layer 210 of epoxy material is located above the spacer component 208, between the planar lightwave circuit 204 and the spacer component 208. A second layer 212 of epoxy material is located below the spacer component 208, between the circuit board substrate 206. In this example embodiment, epoxy material is located above and below the spacer component 208. However, in other embodiments the epoxy material may be located only on one side of the spacer component 208 or the other.

The silicon photonics-based interposer 202 is mounted to the circuit board substrate 206 via multiple bumps 214, which may be solder bumps, etc. The silicon photonics-based interposer 202 includes at least one waveguide configured to transmit an optical signal 216. As shown in FIG. 2A, the optical signal 216 is output from a side surface of the silicon photonics-based interposer 202 (and/or received at the side surface), and a side surface of the planar lightwave circuit 204 is aligned with the side surface of the silicon photonics-based interposer 102 to receive the optical signal 216 from the silicon photonics-based interposer 102 (and/or transmit the optical signal 216 to the silicon photonics-based interposer 102). Alignment between the silicon photonics-based interposer 202 and the planar lightwave circuit 204 may be addressed in various axes of alignment, such as a vertical y-axis, a horizontal x-axis, and a z-axis corresponding to the distance between the silicon photonics-based interposer 202 and the planar lightwave circuit 204. Planar rotation may also be accounted for in each axis. Potential alignment and planar rotation issues may be exacerbated because the silicon photonics-based interposer 202 may be coupled along one of its edges to the planar lightwave circuit 204.

Thicknesses of the spacer component 208, the first layer 210 of epoxy material and the second layer 212 of epoxy material may be designed to fix the planar lightwave circuit 204 at a specified height above the circuit board substrate 206, to facilitate optimizing alignment between the silicon photonics-based interposer 202 and the planar lightwave circuit 204 for stable optical coupling of the optical signal 216. In some example embodiments, different thicknesses of the spacer component 208 may be set in different bin ranges, to optimize a process for attaching the planar lightwave circuit 204 and reduce coupling losses.

FIG. 2B is a side sectional view of an optical signal transceiver 200B including a silicon photonics-based interposer 202 and a planar lightwave circuit 204. A spacer component 208 is located below the planar lightwave circuit 204, between the planar lightwave circuit 204 and a circuit board substrate 206. An upper layer 218 of epoxy material is located above the spacer component 208, between the planar lightwave circuit 204 and the spacer component 208. In this example embodiment, epoxy material is located only above the spacer component 208, and not below the spacer component 208 (i.e., there is no epoxy material between the spacer component 208 and the circuit board substrate 206).

Thicknesses of the spacer component 208 and the upper layer 218 of epoxy material may be designed to fix the planar lightwave circuit 204 at a specified height above the circuit board substrate 206, to facilitate optimizing alignment between the silicon photonics-based interposer 202 and the planar lightwave circuit 204 for stable optical coupling of the optical signal 216.

As shown in FIG. 2B, the side surface of the planar lightwave circuit 204 is spaced from the side surface of the silicon photonics-based interposer 202 to define a gap between the side surface of the planar lightwave circuit 204 and the side surface of the silicon photonics-based interposer 202. In some example embodiments, the gap defined between the side surface of the planar lightwave circuit 204 and the side surface of the silicon photonics-based interposer 202 has a width in a range from 1 μm to 3 μm, although other example embodiments may have gaps with different widths. The width of the gap may be designed for facilitating strong optical coupling between the side surface of the planar lightwave circuit 204 and the side surface of the silicon photonics-based interposer 202 for stable transmission of the optical signal 216.

The gap may be uniform to maintain strong optical coupling between the planar lightwave circuit 204 and the silicon photonics-based interposer 202. Tolerances for the gap distance are also small, although they may not be as strict as the tolerances for the vertical and horizontal alignment of the planar lightwave circuit 204 and the silicon photonics-based interposer 202. For example, while a 1.5 micron misalignment in a vertical or horizontal direction may lead to, e.g., a 1 dB loss, a 1.5 micron variation in the width of the gap may cause a smaller loss. While the spacer component 208 primarily facilitates alignment of a height of the planar lightwave circuit 204 in a vertical direction, the spacer component 208 may also help achieve an appropriate gap between the planar lightwave circuit 204 and the silicon photonics-based interposer 202 by reducing movement of the planar lightwave circuit 204 relative to the circuit board substrate 206 due to use of less epoxy material, due to closer matched thermal coefficients of the materials, etc.

FIG. 2C is a side sectional view of an optical signal transceiver 200C including a silicon photonics-based interposer 202 and a planar lightwave circuit 204. A spacer component 208 is located below the planar lightwave circuit 204, between the planar lightwave circuit 204 and a circuit board substrate 206. A lower layer 220 of epoxy material is located below the spacer component 208, between the circuit board substrate 206 and the spacer component 208. In this example embodiment, epoxy material is located only below the spacer component 208, and not above the spacer component 208 (i.e., there is no epoxy material between the spacer component 208 and the planar lightwave circuit 204).

Thicknesses of the spacer component 208 and the lower layer 220 of epoxy material may be designed to fix the planar lightwave circuit 204 at a specified height above the circuit board substrate 206, to facilitate optimizing alignment between the silicon photonics-based interposer 202 and the planar lightwave circuit 204 for stable optical coupling of the optical signal 216.

In some example embodiments, one or more light generator devices may be optically coupled to the silicon photonics-based interposer 202, where the silicon photonics-based interposer 202 receives an optical output from the one or more light generator devices. The light generator device(s) may include, for example, a laser, an optical amplifier, a resonator, etc. The silicon photonics-based interposer 202 may include at least one photo detector configured to detect optical communication signals. For example, the silicon photonics-based interposer 202 may be configured to convert optical signals received from the planar lightwave circuit 204 into electrical signals (e.g., for use by electrical circuit components on the circuit board substrate 206), and/or may convert electrical signals into optical communication signals for transmission to optical fibers of a communication network via the planar lightwave circuit 204.

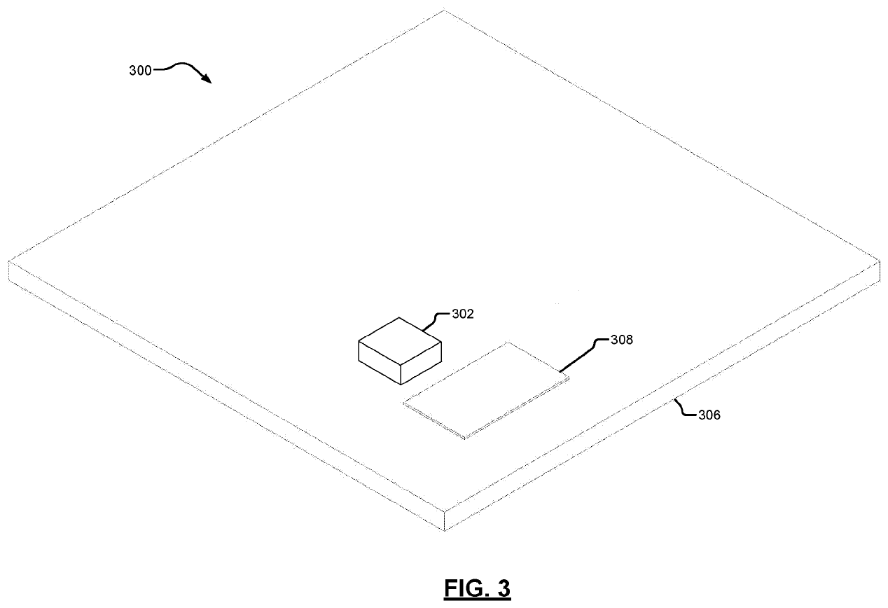

FIG. 3 is an orthogonal view of an assembly 300 including a silicon photonics-based interposer 302 and a spacer component 308 on a circuit board substrate 306. The spacer component 308 (and other spacer components described herein) may include any suitable material for spacing a planar lightwave circuit from the substrate, such as a silicon material, a silicon dioxide material, or a glass material. In some example embodiments, a thermal coefficient of the spacer component 308 is equal to a thermal coefficient of the planar lightwave circuit, which may reduce or minimize warpage induced due to a mismatch between coefficients of thermal expansion between the circuit board substrate 306 and the spacer component 308 that could cause variations in optical coupling between the silicon photonics-based interposer 302 and a planar lightwave circuit.

In some example embodiments, the spacer component 308 may not have any circuit elements or electrical components formed thereon or coupled thereto (e.g., the spacer component 308 is absent any circuit elements), and may be considered as a “dummy” spacer component. The spacer component 308 may be disposed on the circuit board substrate 306 with a layer of epoxy material between the spacer component 308 and the circuit board substrate 306 (such as illustrated in FIGS. 2A and 2C), or may be disposed directly on the circuit board substrate 306 (such as illustrated in FIG. 2B).

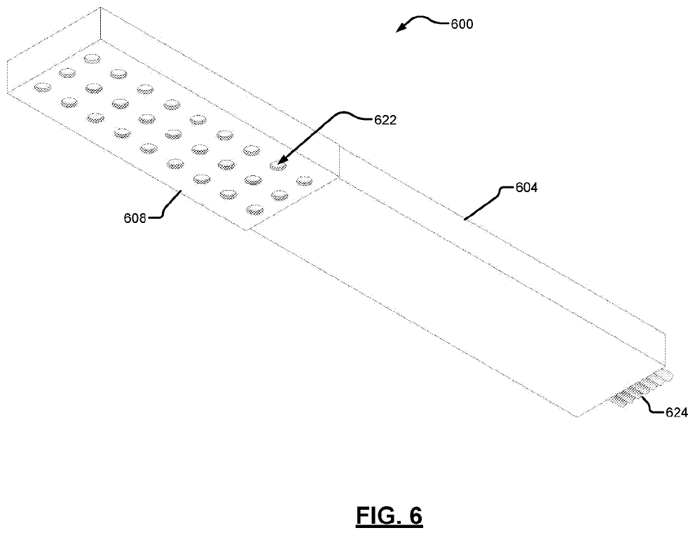

In some example embodiments, the spacer component 308 may be embedded in the circuit board substrate 306, or may be disposed on a surface of a planar lightwave circuit (such as illustrated in FIGS. 2C and 6). Embedding the spacer component 308 in the circuit board substrate 306 during substrate manufacturing may reduce a mismatch of a coefficient of thermal expansion of the different materials related to the stack up of the planar lightwave circuit assembly. The circuit board substrate 306 may be fabricated from any suitable substrate for mounting optical signal transceiver components, circuit elements, etc., such as an organic substrate. In some example embodiments, the circuit board substrate 306 may be considered as a planar circuit substrate.

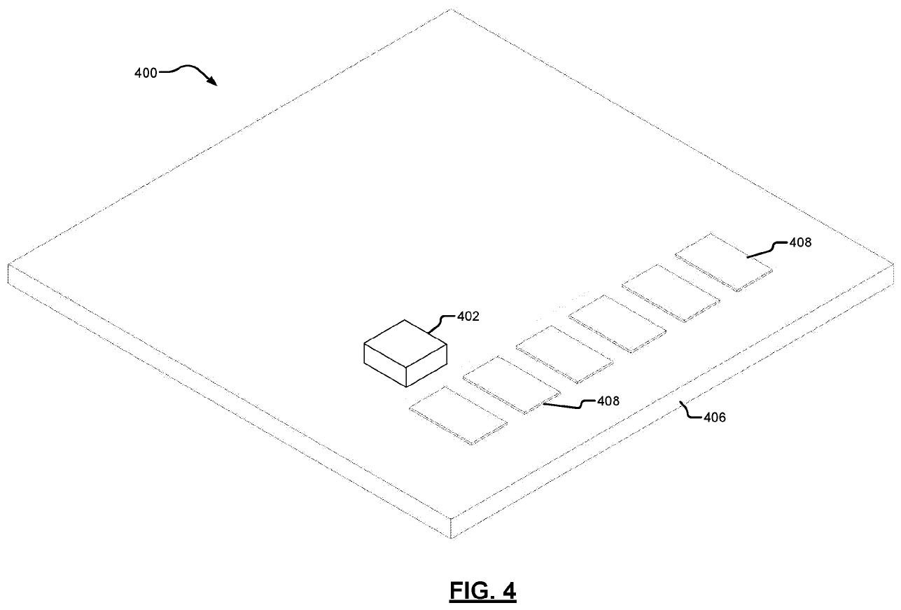

FIG. 4 is an orthogonal view of an assembly 400 including a silicon photonics-based interposer 402 and multiple spacer components 408 disposed on a circuit board substrate 406. For example, instead of a single spacer component located between a planar lightwave circuit and the circuit board substrate 406, multiple spacer components 408 may be disposed between the planar lightwave circuit and the circuit board substrate 406.

As shown in FIG. 4, each spacer component 408 is coplanar with the other spacer components 408. The spacer components 408 are arranged in a line (e.g., a cascade arrangement), with a gap defined between adjacent spacer components. In other example embodiments, more or fewer spacer components than shown may be used. Likewise, the spacer components may be arranged differently relative to one another, etc.

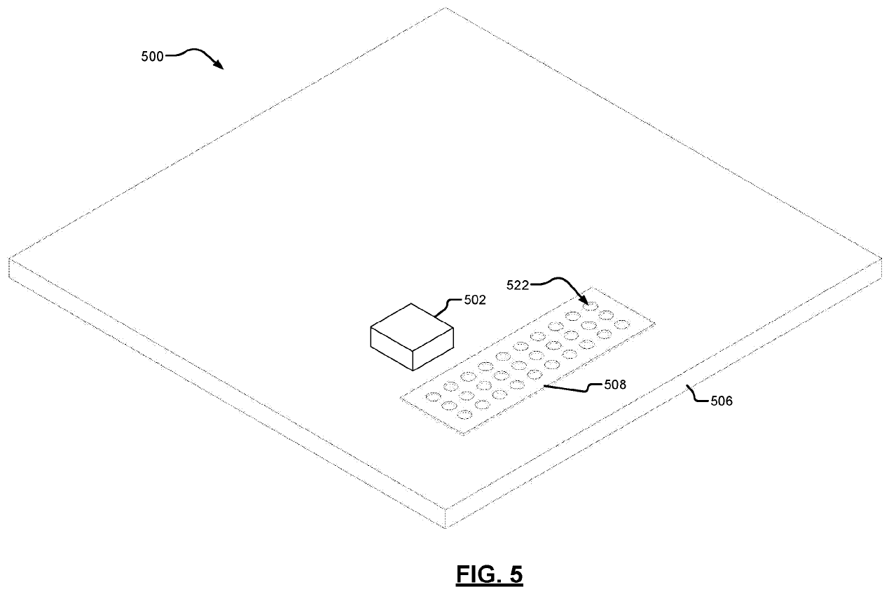

FIG. 5 is an orthogonal view of an assembly 500 including a silicon photonics-based interposer 502 and a spacer component 508 on a circuit board substrate 506. The spacer component 508 includes multiple openings 522. Each opening 522 extends from an upper surface of the spacer component 508 to a lower surface of the spacer component 508. For example, each opening 522 may be defined by a space between the upper surface and the lower surface.

The openings 522 may be arranged in one or more rows, such as the honeycomb pattern illustrated in FIG. 5. Epoxy material may be arranged to fill at least a portion of the openings 522, to facilitate desired vertical spacing when coupling a planar lightwave circuit to the circuit board substrate 506 using the spacer component 508 and epoxy material. For example, the openings 522 may provide a space for excess epoxy material in the event of an overfill, thereby enabling a more exact vertical positioning of the planar lightwave circuit. In other example embodiments, the spacer component may include more or less openings, openings arranged in a different pattern, etc. The multiple openings 522 may reduce or minimize a contact area between the spacer component 508 and the circuit board substrate 506, to reduce or minimize warpage due to a mismatch in coefficients of thermal expansion between the spacer component 508 and the circuit board substrate 506.

FIG. 6 is an orthogonal view of a device 600 including a spacer component 608 located on a bottom surface of a planar lightwave circuit 604. The spacer component 608 includes multiple openings 622 arranged in a honeycomb pattern. In this example embodiment, the spacer component 608 may be coupled to the planar lightwave circuit 604 initially, then epoxy material may be applied to a surface of a circuit board substrate, on the surface of the spacer component 608, and/or in the openings 622 of the spacer component, in order to couple the planar lightwave circuit 604 to a circuit board substrate. For example, the spacer component 608 may be attached to the planar lightwave circuit 604 during the planar lightwave circuit fabrication process, or subsequent to the planar lightwave circuit fabrication process, to make assembly of the planar lightwave circuit 604 with the spacer component 608 more efficient. The planar lightwave circuit 604 includes multiple optical connectors 624 configured to transmit and/or receive optical communication signals.

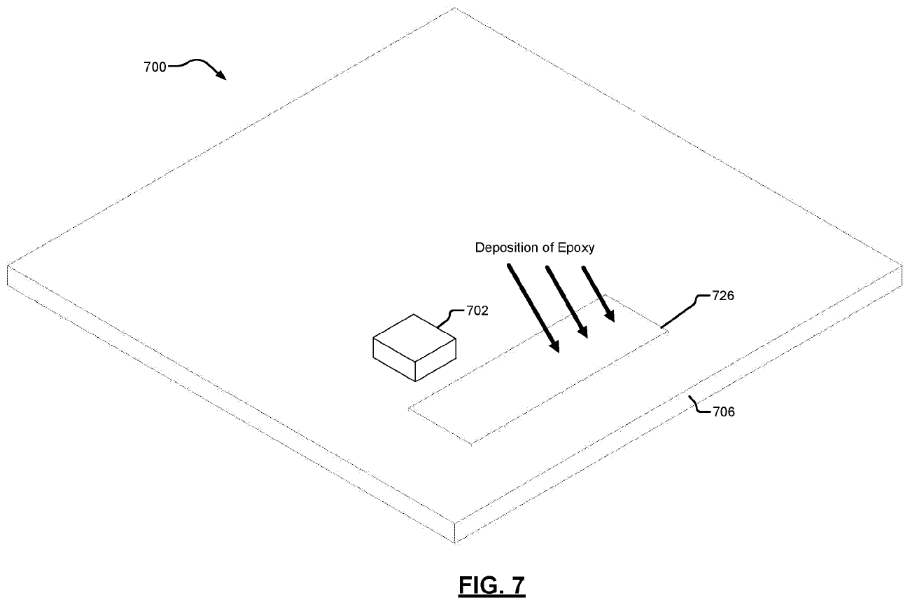

FIG. 7 is an orthogonal view of an assembly 700 including a silicon photonics-based interposer 702 and a metal layer 726 on a circuit board substrate 706. For example, the circuit board substrate 706 may include an exposed metal layer 726 to facilitate mounting of a planar lightwave circuit.

Epoxy material may be disposed on the exposed metal layer 726, for adhering to a spacer component (e.g., with the epoxy material disposed between the exposed metal layer 726 and the spacer component). The exposed metal layer 726 may include any suitable metal material, such as Electroless Nickel Electroless Palladium Immersion Gold (ENEPIG) plating.

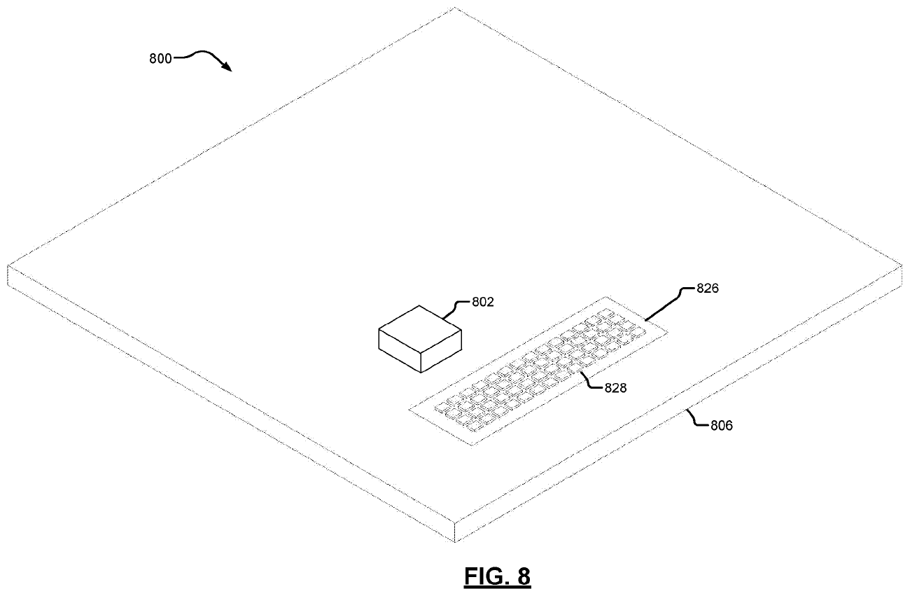

FIG. 8 is an orthogonal view of an assembly 800 including a silicon photonics-based interposer 802 and a metal layer 826 on a circuit board substrate 806. The metal layer 826 includes a patterned surface 828. For example, the metal layer 826 may a pattern of alternating metal and solder resist portions.

The exposed metal layers 726 and 826 may provide a flat surface to secure the spacer component(s) with a controlled epoxy material thickness. Creating a patterned surface 828 (e.g., using a combination of metal portions and solder resist portions), may provide a stronger bonding strength in the interface between the spacer component and the substrate.

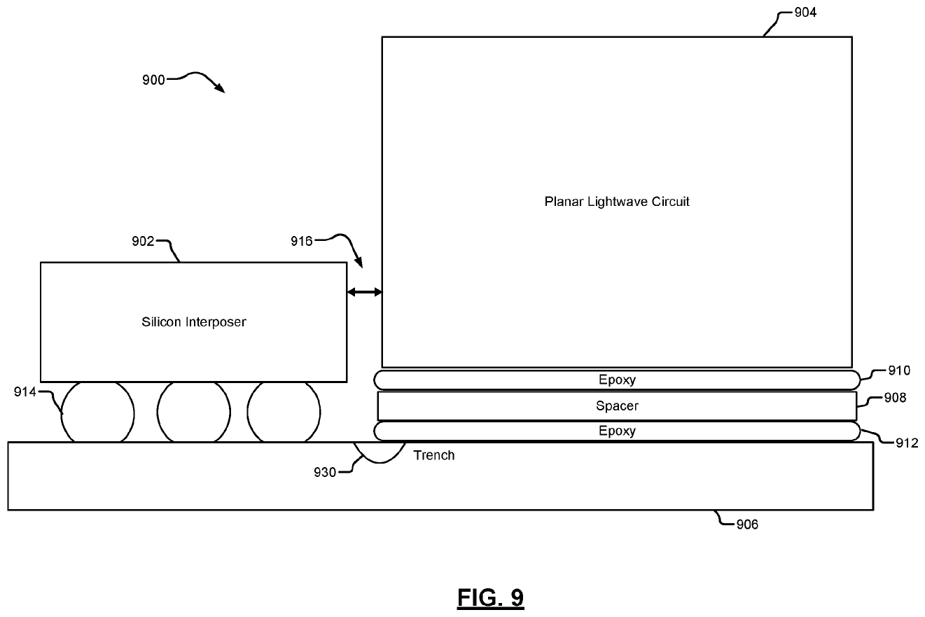

FIG. 9 is a side sectional view of an optical signal transceiver 900 including a silicon photonics-based interposer 902 and a planar lightwave circuit 904. A spacer component 908 is located between the planar lightwave circuit 904 and a circuit board substrate 906, with epoxy material layers 910 and 912 located above and below the spacer component 908.

The silicon photonics-based interposer 902 is mounted to the circuit board substrate 906 via multiple bumps 914, which may be solder bumps, etc. As shown in FIG. 9, the optical signal 916 is output from a side surface of the silicon photonics-based interposer 902 (and/or received at the side surface), and a side surface of the planar lightwave circuit 904 is aligned with the side surface of the silicon photonics-based interposer 902 to receive the optical signal 916.

Thicknesses of the spacer component 908, and the layers 910 and 912 of epoxy material may be designed to fix the planar lightwave circuit 904 at a specified height above the circuit board substrate 906, to facilitate optimizing alignment between the silicon photonics-based interposer 902 and the planar lightwave circuit 904 for stable optical coupling of the optical signal 916.

The example embodiment of FIG. 9 includes a trench 930 defined in the circuit board substrate 906. The trench 930 is located at an edge of the layer 912 of epoxy material, and is configured to collect any excess epoxy material that may be squeezed out of the epoxy material layer 912, etc., as the planar lightwave circuit 904 is mounted on the circuit board substrate 906. For example, as the planar lightwave circuit 904 is pressed down on the spacer component 908 and the layers 910 and 912 of epoxy material, extra epoxy material may flow into the trench 930 instead of moving across the circuit board substrate to contact other components of the optical signal transceiver, etc. The trench 930 may assist in controlling a thickness of the epoxy material, for example, by allowing the planar lightwave circuit 904 to be set at a desired height while variations in the amount of epoxy material applied during fabrication are collected by the trench 930.

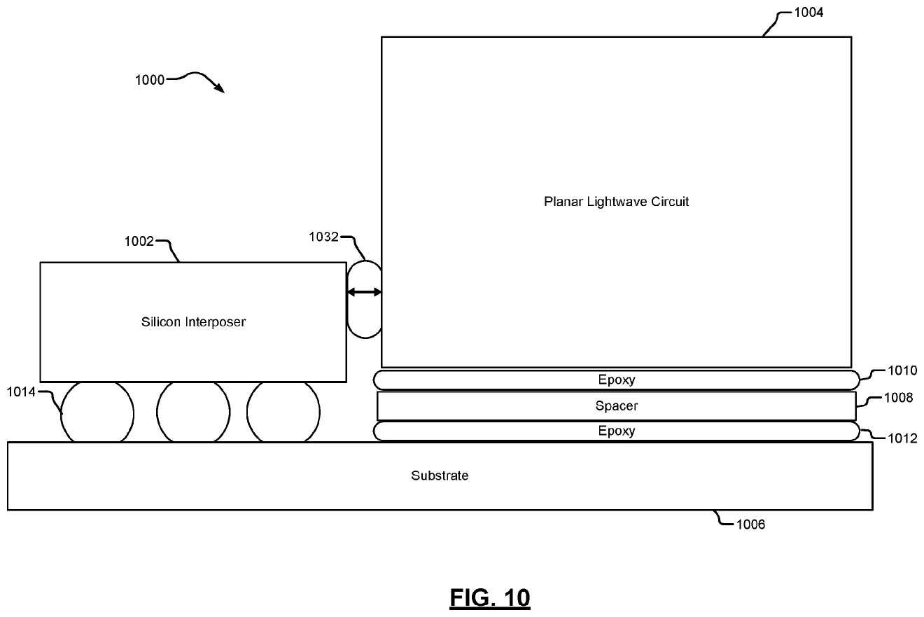

FIG. 10 is a side sectional view of an optical signal transceiver 1000 including a silicon photonics-based interposer 1002 and a planar lightwave circuit 1004. A spacer component 1008 is located below the planar lightwave circuit 1004, between the planar lightwave circuit 1004 and a circuit board substrate 1006, with epoxy material layers 1010 and 1012 located above and below the spacer component 1008.

The silicon photonics-based interposer 1002 is mounted to the circuit board substrate 1006 via multiple bumps 1014, which may be solder bumps, etc. As shown in FIG. 10, an optical signal is output from a side surface of the silicon photonics-based interposer 1002 (and/or received at the side surface), and a side surface of the planar lightwave circuit 1004 is aligned with the side surface of the silicon photonics-based interposer 1002 to receive the optical signal.

In the example embodiment of FIG. 10, epoxy material 1032 is located in a gap between the side surface of the silicon photonics-based interposer 1002 and the side surface of the planar lightwave circuit 1004, which may enhance optical coupling between the silicon photonics-based interposer 1002 and the planar lightwave circuit 1004.

For example, the epoxy material 1032 may have a refractive index which is matched to a refractive index of at least one of the silicon photonics-based interposer 1002 and the planar lightwave circuit 1004. The epoxy material 1032 may be the same type of epoxy material as the epoxy material of the layers 1010 and 1012, or may be a different epoxy material.

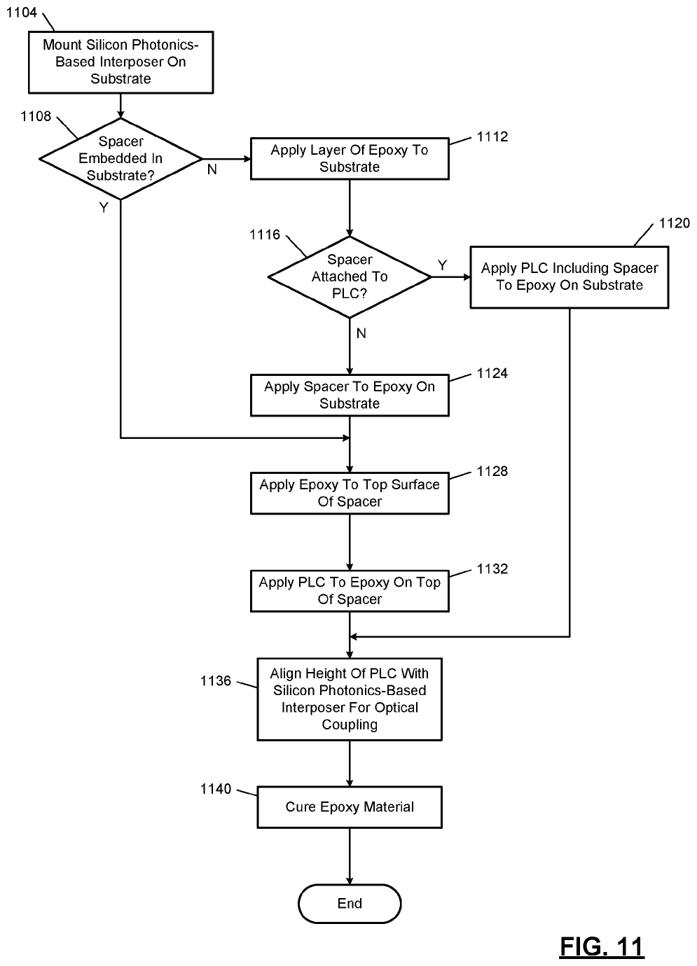

FIG. 11 is a flowchart illustrating an example process for fabricating an optical signal transceiver including a silicon photonics-based interposer and a planar light wave circuit, using a spacer component and epoxy material. At 1104, the process starts by mounting a silicon photonics-based interposer on a substrate (such as mounting the silicon photonics-based interposer 202 of FIG. 2A on the circuit board substrate 206).

At 1108, the process determines whether a spacer component is already embedded in the substrate. If not, at 1112 a layer of epoxy is applied to the circuit board substrate (e.g., epoxy material may not be applied to the substrate when the spacer component is already embedded in the substrate).

At 1116, the process determines whether the spacer component is attached to the planar lightwave circuit (such as the spacer component 608 mounted to the planar lightwave circuit 604 in FIG. 6). If so, at 1120 the process applies the planar lightwave circuit to the epoxy material on the circuit board substrate. For example, if the spacer component is already attached to the planar lightwave circuit, the combined planar lightwave circuit and spacer component may be applied together directly onto the epoxy material, to couple the spacer component and the planar lightwave circuit to the substrate.

If the process determines that the spacer component is not attached to the planar lightwave circuit, at 1124 the spacer component is applied to the epoxy material on the substrate. After applying the spacer component to the epoxy material, or if the spacer component is already embedded in the substrate, at 1128 the epoxy material is applied to a top surface or the spacer. At 1132, planar lightwave circuit is applied to the epoxy material on top of the spacer.

At 1136, a height of the planar lightwave circuit is aligned with a height of the silicon photonics-based interposer, to facilitate optical coupling between the planar lightwave circuit and the silicon photonics-based interposer. For example, the planar lightwave circuit may be raised or lowered on top of the epoxy material and spacer component to align a receiving side surface portion of the planar lightwave circuit with a portion of the silicon photonics-based interposer which outputs an optical signal (and/or receives an optical signal).

At 1140, the process includes curing the epoxy material. If the optical signal transceiver includes two layers of epoxy material (e.g., above and below the spacer component), both layers of the epoxy material may be cured concurrently (e.g., at the same time). Curing the epoxy layers concurrently may reduce or minimize a process cycle time, to improve throughput. Optionally, the process may include filling openings of the spacer component with epoxy material when the spacer component includes one or more openings, and the process may include applying epoxy material in a gap between side surfaces of the planar lightwave circuit and the silicon photonics-based interposer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “coupled,” “adjacent,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, apparatus elements described as having particular attributes or performing particular operations are specifically configured to have those particular attributes and perform those particular operations. Specifically, a description of an element to perform an action means that the element is configured to perform the action.

Although the terms first, second, third, etc. may be used herein to describe various elements, components, and/or regions, these elements, components, and/or regions should not be limited by these terms, unless otherwise indicated. These terms may be only used to distinguish one element, component, and/or region from another circuit element, component, and/or region. Terms such as “first,” “second,” and other numerical terms when used herein do not imply a sequence or order unless clearly indicated by the context. Thus, a first element, component, and/or region could be termed a second circuit element, component, and/or region without departing from the teachings of the example embodiments.

What is claimed is:

1. An optical signal transceiver comprising:
a circuit board substrate;
a silicon photonics-based interposer mounted on the circuit board substrate, the silicon photonics-based interposer including at least one of a waveguide configured to transmit optical communication signals and a photo detector configured to detect optical communication signals;
a planar lightwave circuit disposed on the circuit board substrate, the planar lightwave circuit configured to perform at least a portion of propagation of light signals in an optical communication network, the planar lightwave circuit aligned with a side surface of the silicon photonics-based interposer to transmit optical communication signals between the silicon photonics-based interposer and the planar lightwave circuit;
at least one spacer component disposed between the planar lightwave circuit and the circuit board substrate; and
epoxy material in contact with the spacer component.

2. The optical signal transceiver of claim 1, wherein the epoxy material is disposed between the planar lightwave circuit and the at least one spacer component, or the epoxy material is disposed between the at least one spacer component and the circuit board substrate.

3. The optical signal transceiver of claim 2, wherein:
a first portion of the epoxy material is disposed between the planar lightwave circuit and the at least one spacer component; and
a second portion of the epoxy material is disposed between the at least one spacer component and the circuit board substrate.

4. The optical signal transceiver of claim 1, wherein the at least one spacer component comprises at least one of a silicon material, a silicon dioxide material or a glass material.

5. The optical signal transceiver of claim 4, wherein the at least one spacer component is absent any circuit elements.

6. The optical signal transceiver of claim 1, wherein the at least one spacer component is embedded in the circuit board substrate.

7. The optical signal transceiver of claim 1, wherein:
a side surface of the planar lightwave circuit is spaced from the side surface of the silicon photonics-based interposer to define a gap between the side surface of the planar lightwave circuit and the side surface of the silicon photonics-based interposer, the at least one spacer component and the epoxy material located at a different surface of the planar lightwave circuit than the side surface of the planar lightwave circuit facing the silicon photonics-based interposer; and
at least a portion of the epoxy material is disposed in the gap defined between the side surface of the planar lightwave circuit and the side surface of the silicon photonics-based interposer.

8. The optical signal transceiver of claim 7, wherein a refractive index of the portion of the epoxy material disposed in the gap formed between the side surface of the planar lightwave circuit and the side surface of the silicon photonics-based interposer is matched to the refractive index of at least one of the silicon photonics-based interposer and the planar lightwave circuit.

9. The optical signal transceiver of claim 1, wherein:
the at least one spacer component includes a first spacer component and a second spacer component; and
the first spacer component and the second spacer component are coplanar, and a gap is defined between the first spacer component and the second spacer component.

10. The optical signal transceiver of claim 1, further comprising at least one laser diode coupled to the silicon photonics-based interposer, wherein the silicon photonics-based interposer is configured to receive an optical output from the at least one laser diode.

11. The optical signal transceiver of claim 1, wherein the at least one spacer component includes an upper surface, a lower surface, and at least one opening defined by a space between the upper surface and the lower surface.

12. The optical signal transceiver of claim 1, wherein the at least one spacer component includes multiple openings arranged in at least one row.

13. The optical signal transceiver of claim 12, wherein at least a portion of the epoxy material is disposed in one or more of the multiple openings of the at least one spacer component.

14. The optical signal transceiver of claim 1, wherein:
the circuit board substrate includes an exposed metal plating layer; and
at least a portion of the epoxy material is disposed between the at least one spacer component and the exposed metal plating layer.

15. The optical signal transceiver of claim 1, wherein a trench, defined in the circuit board substrate adjacent an edge of the at least one spacer component, is configured to receive portions of the epoxy material.

16. The optical signal transceiver of claim 1, wherein a thermal coefficient of the at least one spacer component matches a thermal coefficient of the planar lightwave circuit.

17. The optical signal transceiver of claim 1, wherein the planar lightwave circuit includes one or more passive components, the one or more passive components including at least one optical waveguide.

18. The optical signal transceiver of claim 1, wherein the circuit board substrate is an organic substrate.

19. A method of assembling an optical signal transceiver, the method comprising:
mounting a silicon photonics-based interposer on a circuit board substrate, the silicon photonics-based interposer including at least one of a waveguide configured to transmit optical communication signals and a photo detector configured to detect optical communication signals;
mounting a planar lightwave circuit on the circuit board substrate, wherein at least one spacer component is disposed between the planar lightwave circuit and the circuit board substrate, and an epoxy material is in contact with the circuit board substrate; and
adjusting a height of the planar lightwave circuit relative to the silicon photonics-based interposer to align the planar lightwave circuit with a side surface of the silicon photonics-based interposer to transmit optical communication signals between the silicon photonics-based interposer and the planar lightwave circuit.

20. The method of claim 19, further comprising:
applying a first portion of the epoxy material between the at least one spacer component and the circuit board substrate; and
applying a second portion of the epoxy material between the at least one spacer component and the planar lightwave circuit.

21. The method of claim 20, further comprising concurrently curing the first portion of the epoxy material and the second portion of the epoxy material.

22. The method of claim 20, further comprising attaching the at least one spacer component to the planar lightwave circuit prior to mounting the planar lightwave circuit on the circuit board substrate.
